(19) United States
(12) Patent Application Publication
(10) Pub. No.: US 2023/0204816 A1
(43) Pub. Date: Jun. 29, 2023

(54) MODELING METHODS FOR MINIMIZING GRID SENSITIVITY FOR NUMERICAL SIMULATION OF FRACTURE PROPAGATION

(71) Applicant: ExxonMobil Upstream Research Company, Spring, TX (US)

(72) Inventors: Vadim DYADECHKO, The Woodlands, TX (US); Dakshina M. VALIVETI, Conroe, TX (US); Ting SONG, Tomball, TX (US)

(21) Appl. No.: 18/000,331

(22) PCT Filed: Mar. 10, 2021
(86) PCT No.: PCT/US2021/021666

§ 371 Date: Nov. 30, 2022

Related U.S. Application Data
(60) Provisional application No. 63/035,026, filed on Jun. 5, 2020.

(51) Int. Cl. G01V 99/00

(52) U.S. Cl. CPC G01V 99/005; G01V 2210/646; G01V 2210/663

(57) ABSTRACT

A computer-implemented geological modeling method is disclosed. Hydraulic fracturing includes pumping fluids through a wellbore/casing and into a formation through perforations, creating fractures that can improve well productivity. Geological modeling may be used to model pumping of fluids into the subsurface to achieve a desired fracturing result. However, the grid used may affect the fracture propagation calculations used for geological modeling. Thus, a methodology is disclosed which reduces the grid dependence when determining various aspects of fracturing, such as pressure and/or aperture. The methodology uses a first correction factor that is based on the grid used to determine fracture propagation and a second correction factor that is not based on the grid used to determine fracture propagation (such as based on an ideal grid). In this way, the two correction factors are derived from different aspects, which when combined, may be used to reduce grid dependence when determining fracture propagation.

### CROSS REFERENCE TO RELATED APPLICATIONS

This application is the U.S. National Stage Application of the International Application No. PCT/US2021/021666, entitled “Modeling Methods for Minimizing Grid Sensitivity for Numerical Simulation Of Fracture Propagation,” filed on Mar. 10, 2021, the disclosure of which is hereby incorporated by reference in its entirety, which claims benefit of U.S. Provisional Patent Application Ser. No. 63/035,026, entitled “Modeling Methods for Minimizing Grid Sensitivity for Numerical Simulation Of Fracture Propagation,” filed Jun. 5, 2020, the disclosure of which is hereby incorporated by reference in its entirety.

### FIELD OF THE INVENTION

The present application relates generally to the field of analyzing fracture propagation in a material. Specifically, the disclosure relates to a methodology for reducing or minimizing grid sensitivity when numerically simulating fracture propagation for hydraulic fracturing in hydrocarbon exploration.

### BACKGROUND OF THE INVENTION

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

A geologic model is a computer-based representation, such as a two-dimensional (“2D”) representation or a three-dimensional (“3D”) representation, of a region beneath the earth's surface. Such models may be used to model a petroleum reservoir, a depositional basin, or other regions which may have valuable mineral resources. Once the model is constructed, it may be used for various purposes, many of which are intended to facilitate efficient and economical recovery of the valuable resources. For example, the geologic model may be used as an input to simulations of petroleum reservoir fluid flows during production operations, which are used to plan well placements and predict hydrocarbon production from a petroleum reservoir over time.

When performing reservoir simulations, geologic models are typically divided into a grid or mesh of volumetric cells, i.e., volumetric elements having material properties values that are constant (or otherwise well-defined) within each cell.

Unconventional reservoirs often have a low-permeability rock matrix that impedes fluid flow, making it difficult to extract hydrocarbons (or other fluids of interest) at commercially feasible rates and volumes. However, the effective permeability of the formation can be increased by hydraulic fracturing. When the rock matrix is exposed to a high-pressure high-volume flow of a relatively incompressible fluid, the low permeability causes sharp gradients in the formation's stress field, resulting in fractures in the rock matrix. Specifically, the process of hydraulic fracturing may comprise pumping fluids down at a prescribed flow rate through the wellbore/casing and into the formation through perforations. When the fluid pressure exceeds the rock breakdown pressure, it creates a fracture in the formation. Proppants, such as sand, are pumped with fracturing fluid to keep the fracture open after release of pumping pressure. Such fractures often occur as sudden “cracking” or fracturing of the matrix that momentarily reduces the stress gradient until it can be rebuilt by the intruding fluid flow. As the high-pressure flow continues, the fractures may propagate, for example, as an intermittent series of small cracks. The injected fluid also deforms and shifts blocks of matrix material, further complicating the fracture propagation analysis. In this regard, hydraulic fracturing has been widely used and proven to be one of the most effective techniques to improve well productivity by forming high permeable pathways for hydrocarbons to flow from the rock formation to the wellbore.

Oilfield operators generally desire to provide a relatively even distribution of fractures throughout the reservoir while avoiding overlap in the fractures connecting to different wells or different production zones in a single well. (Such overlaps or uneven distributions may dramatically reduce the rate and efficiency at which fluid can be drained from that region.) To achieve the desired distribution, operators seek to induce fracturing with carefully controlled fracture reach (“extent”). Inaccuracies in predicting and controlling fracture extent significantly impair the efficiency and rate at which fluids can be recovered from the formation. The complexity of underlying physics, the uncertainty involved with subsurface flow and mechanical properties result in significant emphasis on numerical modeling and simulation for such processes. In particular, a numerical method may be used to solve the governing equations of fluid flow and rock deformation to estimate/predict the effectiveness of a fracturing treatment. The solution to this coupled system of equations also drives the fracture propagation in the rock medium.

Various methods may be used to simulate fracture propagation. For example, the initiation of a fracture may be at the cell interface (e.g., between two cells) in a numerical scheme such as Finite Element Method. The fracture may then continue to propagate, driven by pumped fluid into the fractures or pore-pressure changes. For example, when σ_{cell}>σ_{cr}, the fracture may propagate, where σ_{cell}, is the stress associated with the cell (e.g., the stress at the cell interface or the stress in a center of the cell) and where σ_{cr} is the critical stress of the material where fracturing will occur. However, in any grid-based fracture propagation method, the resulting fracture dimensions are dependent on the grid size. One cause for this grid sensitivity is because the method aims at solving a problem with 1/\sqrt{r} singularity for stress with a linear element at the crack tip, where r is the radius from the crack tip.

One approach to countering the grid dependence includes adding special enrichment functions that have some form of 1/\sqrt{r} at crack tip. These are referred as enriched or extended finite element schemes. While this approach provides some relief from grid sensitivity, it requires special methods of discretization that increase integration requirements, with the problem size growing as the fracture grows.

Another approach comprises a non-local approach, whereby the stresses around the crack tip in a specified radius ‘R’ are averaged and used for propagation criterion. Instead of using σ_{cell}>σ_{cr}, the method uses σ_{cell}^{avg}>σ_{cr}. This method reduces the sensitivity of propagation to stresses in one specific cell, by averaging from a group of cells around the crack tip and may reduce grid sensitivity. However, the method computing the average of stresses at the end of each step can become a bottleneck for massive parallel simulations.

### SUMMARY OF THE INVENTION

In one or some embodiments, a computer-implemented geologic modeling method is disclosed. The method includes: accessing a geologic model representing a subsurface region as a grid of cells, at least some of the cells in the grid having one or more interfaces representing boundaries of subsurface structures including at least one natural or induced fracture; determining, using a specific solving methodology, a fracture extension to the at least one natural or induced fracture into at least one cell in the grid by comparing stress associated with the at least one cell with critical stress associated with a material of the at least one cell, the determination using at least one correction factor correlating at least one aspect of the at least one cell in the grid with at least one aspect unrelated to the grid; and using the fracture extension in order to control at least one aspect of hydraulic fracturing in the subsurface region.

In one or some embodiments, a computer-implemented geologic modeling method is disclosed. The method includes: determining a uniform grid of cells in order to represent a subsurface region by selecting a size of the cells in the uniform grid so that determinations of stress for the cells in the uniform grid for a specific solving methodology are in agreement with a true solution, at least some of the cells in the grid having one or more interfaces representing boundaries of subsurface structures including at least one natural or induced fracture; determining, using the specific solving methodology, a fracture extension to the at least one natural or induced fracture into at least one cell in the grid by comparing stress associated with the at least one cell with critical stress associated with a material of the at least one cell; and using the fracture extension in order to control at least one aspect of hydraulic fracturing in the subsurface region.

### BRIEF DESCRIPTION OF THE DRAWINGS

The present application is further described in the detailed description which follows, in reference to the noted plurality of drawings by way of non-limiting examples of exemplary implementations, in which like reference numerals represent similar parts throughout the several views of the drawings. In this regard, the appended drawings illustrate only exemplary implementations and are therefore not to be considered limiting of scope, for the disclosure may admit to other equally effective embodiments and applications.

FIG. 1A shows an illustrative measured seismic image volume.

FIG. 1B shows an illustrative 3-D subsurface model.

FIG. 1C shows an illustrative 2-D subsurface model.

FIG. 2 is a data flow diagram for the illustrative subsurface modeling system.

FIG. 3 is a flow diagram of an illustrative subsurface modeling method.

FIG. 4 is a flow diagram of an illustrative fracturing simulation.

FIG. 5A shows vertices in an illustrative 2D model.

FIG. 5B illustrates one approach to fracture propagation in the model of FIG. 5A.

FIG. 6 is an illustration of a Kristianovich-Geertsma-de Klerk (KGD) propagation benchmark model

FIG. 7 is a graph of the numerical result for pressure with time for the KGD problem.

FIG. 8 is a graph of the numerical result for aperture with time for the KGD problem.

FIG. 9 is a diagram of an exemplary computer system that may be utilized to implement the methods described herein.

### DETAILED DESCRIPTION OF THE INVENTION

The methods, devices, systems, and other features discussed below may be embodied in a number of different forms. Not all of the depicted components may be required, however, and some implementations may include additional, different, or fewer components from those expressly described in this disclosure. Variations in the arrangement and type of the components may be made without departing from the spirit or scope of the claims as set forth herein. Further, variations in the processes described, including the addition, deletion, or rearranging and order of logical operations, may be made without departing from the spirit or scope of the claims as set forth herein.

It is to be understood that the present disclosure is not limited to particular devices or methods, which may, of course, vary. It is also to be understood that the terminology used herein is for the purpose of describing particular embodiments only, and is not intended to be limiting. As used herein, the singular forms “a,” “an,” and “the” include singular and plural referents unless the content clearly dictates otherwise. Furthermore, the words “can” and “may” are used throughout this application in a permissive sense (i.e., having the potential to, being able to), not in a mandatory sense (i.e., must). The term “include,” and derivations thereof, mean “including, but not limited to.” The term “coupled” means directly or indirectly connected. The word “exemplary” is used herein to mean “serving as an example, instance, or illustration.” Any aspect described herein as “exemplary” is not necessarily to be construed as preferred or advantageous over other aspects. The term “uniform” means substantially equal for each sub-element, within about ±10% variation.

The term “seismic data” as used herein broadly means any data received and/or recorded as part of the seismic surveying and interpretation process, including displacement, velocity and/or acceleration, pressure and/or rotation, wave reflection, and/or refraction data. “Seismic data” is also intended to include any data (e.g., seismic image, migration image, reverse-time migration image, pre-stack image, partially-stack image, full-stack image, post-stack image or seismic attribute image) or interpretation quantities, including geophysical properties such as one or more of: elastic properties (e.g., P and/or S wave velocity, P-Impedance, S-Impedance, density, attenuation, anisotropy and the like); and porosity, permeability or the like, that the ordinarily skilled artisan at the time of this disclosure will recognize may be inferred or otherwise derived from such data received and/or recorded as part of the seismic surveying and interpretation process. Thus, this disclosure may at times refer to “seismic data and/or data derived therefrom,” or equivalently simply to “seismic data.” Both terms are intended to include both measured/recorded seismic data and such derived data, unless the context clearly indicates that only one or the other is intended. “Seismic data” may also include data derived from traditional seismic (i.e., acoustic) data sets in conjunction with other geophysical data, including, for example, gravity plus seismic; gravity plus electromagnetic plus seismic data, etc. For example, joint-inversion utilizes multiple geophysical data types.

The terms “velocity model,” “density model,” “physical property model,” or other similar terms as used herein refer to a numerical representation of parameters for subsurface regions. Generally, the numerical representation includes an array of numbers, typically a 2-D or 3-D array, where each number, which may be called a “model parameter,” is a value of velocity, density, or another physical property in a cell, where a subsurface region has been conceptually divided into discrete cells for computational purposes. For example, the spatial distribution of velocity may be modeled using constant-velocity units (layers) through which ray paths obeying Snell's law can be traced. A 3-D geologic model (particularly a model represented in image form) may be represented in volume elements (voxels), in a similar way that a photograph (or 2-D geologic model) is represented by picture elements (pixels). Such numerical representations may be shape-based or functional forms in addition to, or in lieu of, cell-based numerical representations.

Subsurface model is a numerical, spatial representation of a specified region in the subsurface.

Geologic model is a subsurface model that is aligned with specified faults and specified horizons.

Reservoir model is a geologic model where a plurality of locations have assigned properties including any one, any combination, or all of rock type, environment of deposition (EoD), subtypes of EoD (sub-EoD), porosity, permeability, fluid saturations, etc.

For the purpose of the present disclosure, subsurface model, geologic model, and reservoir model are used interchangeably unless denoted otherwise.

Stratigraphic model is a spatial representation of the sequences of sediment and rocks (rock types) in the subsurface.

Structural model or framework results from structural analysis of reservoir based on the interpretation of 2D or 3D seismic images. For examples, the reservoir framework comprises horizons, faults and surfaces inferred from seismic at a reservoir section.

As used herein, “hydrocarbon management” or “managing hydrocarbons” includes any one, any combination, or all of the following: hydrocarbon extraction; hydrocarbon production, (e.g., drilling a well and prospecting for, and/or producing, hydrocarbons using the well; and/or, causing a well to be drilled, e.g., to prospect for hydrocarbons); hydrocarbon exploration; identifying potential hydrocarbon-bearing formations; characterizing hydrocarbon-bearing formations; identifying well locations; determining well injection rates; determining well extraction rates; identifying reservoir connectivity; acquiring, disposing of, and/or abandoning hydrocarbon resources; reviewing prior hydrocarbon management decisions; and any other hydrocarbon-related acts or activities, such activities typically taking place with respect to a subsurface formation. The aforementioned broadly include not only the acts themselves (e.g., extraction, production, drilling a well, etc.), but also or instead the direction and/or causation of such acts (e.g., causing hydrocarbons to be extracted, causing hydrocarbons to be produced, causing a well to be drilled, causing the prospecting of hydrocarbons, etc.). Hydrocarbon management may include reservoir surveillance and/or geophysical optimization. For example, reservoir surveillance data may include, well production rates (how much water, oil, or gas is extracted over time), well injection rates (how much water or CO₂ is injected over time), well pressure history, and time-lapse geophysical data. As another example, geophysical optimization may include a variety of methods geared to find an optimum model (and/or a series of models which orbit the optimum model) that is consistent with observed/measured geophysical data and geologic experience, process, and/or observation.

As used herein, “obtaining” data generally refers to any method or combination of methods of acquiring, collecting, or accessing data, including, for example, directly measuring or sensing a physical property, receiving transmitted data, selecting data from a group of physical sensors, identifying data in a data record, and retrieving data from one or more data libraries.

As used herein, terms such as “continual” and “continuous” generally refer to processes which occur repeatedly over time independent of an external trigger to instigate subsequent repetitions. In some instances, continual processes may repeat in real time, having minimal periods of inactivity between repetitions. In some instances, periods of inactivity may be inherent in the continual process.

If there is any conflict in the usages of a word or term in this specification and one or more patent or other documents that may be incorporated herein by reference, the definitions that are consistent with this specification should be adopted for the purposes of understanding this disclosure.

As discussed in the background, hydraulic fracturing analysis comprises analyzing fractures or cracks in materials (such as rock) in a subsurface. To perform the analysis, various types of grids may be used. As one example, a non-uniform grid may be used in which the sizes of cells within the non-uniform grid are different or non-uniform. In practice, whether analyzing the fracture in 2D or 3D, cells adjacent to the crack tip of the fracture are typically analyzed in order to determine propagation of the fracture. Further, the smaller the size of cells, the greater the computational cost. However, in terms of fracture propagation, cells closer to the initial fracture are typically smaller in size than cells further away from the initial fracture due to the relative size of the fracture versus the size of the cell adjacent the fracture. For example, an initial fracture has a smaller size (e.g., 1 meter) than after the fracture propagates (e.g., 20 or 30 meters). Because the size of the cell may affect the determination of propagation, a smaller cell size (e.g., on the order of 1 meter or less) is placed adjacent to the crack tip of the initial fracture. Otherwise, a larger cell size (e.g., 10 meters) may be too large relative to the size of the initial fracture. Further, as the fracture grows, the size of the cells may likewise grow to reduce the computational burden. However, grid size, particularly non-uniform grid size, may affect fracture propagation calculations.

As discussed in more detail below, the disclosed methodology may reduce mesh or grid dependence when determining various aspects of fracturing (such as pressure and/or aperture). The disclosed methodology may more generally be applied to any aspect in the field of fracture mechanics, which analyzes the propagation of fractures or cracks in materials. In particular, the disclosed methodology may be used as part of the analysis of the physics of stress and strain behavior of materials, such as part of the theories of elasticity and plasticity, to the microscopic crystallographic defects found in real materials in order to predict the macroscopic mechanical behavior of those bodies. Further, the disclosed methodology may be used along with fractography and fracture mechanics to understand the causes of failures and/or to verify the theoretical failure predictions with real life failures. As one example, the disclosed methodology may be applied to determine stress in various materials, such as metal, plastic, or composite materials, in order to determine failure tolerance. In this way, the disclosed methodology may be applied to various industries, such as to the automotive industry (e.g., for determining fractures or cracks in metal, plastics or composites) or to the aerospace industry (e.g., for determining fractures or cracks in metal or composites in the wings or fuselages of airplanes). In this regard, any discussion herein regarding using the disclosed methodology for hydraulic fracturing may equally be applied to any fracture mechanics application, such as to automotive applications or to aerospace applications.

The disclosed methodology may use a correction factor (or other mathematical adjustment) in order to reduce grid dependence in determining fracture propagation. In one or some embodiments, the correction factor may be composed of a first correction factor and a second correction factor. In one specific embodiment, the first correction factor may be based on the grid used to determine fracture propagation, and the second correction factor is not based on the grid used to determine fracture propagation. As discussed in more detail below, the second correction factor may be determined in one of several ways including: (1) based on a different grid than the grid used to determine fracture propagation; (2) based on a benchmark simulator solution; or (3) based on field data (e.g., a correction factor that is used to match with field data). In this regard, the multi-pronged correction factor (e.g., using multiple correction factors) is different from a single correction factor derived from field data. Instead, each correction factor for the multi-pronged correction factor is derived from different aspects, which when combined, may be used to reduce grid dependence when determining fracture propagation.

As one example, the correction factor may be derived from two different grids (such as the characteristic lengths for the two grids), with a first grid being used as the grid for the fracture propagation and the second grid at least partly (or entirely) not being used as the grid for fracture propagation. As one example, the first grid may comprise a non-uniform grid, which may be used to determine fracture propagation, with smaller cells adjacent to crack tip of the initial fracture and larger cells adjacent to the crack tip as the fracture propagates. These cells (whether the smaller cells or the larger cells) have a dimensional aspect relative to the crack tip, one example of which is a characteristic length L_{ch}, whose value varies based on the size of the cell as discussed further below. The second grid, whose cells are at least partly not used for determining fracture propagation, may comprise a uniform grid. Similar to the first grid, the cells in the second grid have a dimensional aspect, one example of which is a characteristic length L_{ch-cr}. Unlike characteristic length L_{ch}, the value of characteristic length L_{ch-cr} does not vary since the cells in the second grid are uniform. In this regard, the correction factor may correlate at least one aspect of the at least one cell in the first grid with at least one aspect of a cell in the second grid (which is different from the first grid).

For example, the characteristic length L_{ch} for a respective cell in the non-uniform grid may be determined based on one or more aspects of the respective cell, such as based on the volume of the respective cell (e.g., assuming a cube shaped cell, the length of the edge of respective cell facing the crack tip is the cube root of the volume of the respective cell); based on an area of the respective cell (e.g., assuming that the area of the surface of the respective cell facing the crack tip is square, the length of the surface is the square root of the area of the surface); or based on the length of the cell (e.g., the length of a side of the respective cell facing the crack tip). Other ways to determine the characteristic length L_{ch} are contemplated. In this way, the characteristic length L_{ch} may vary depending on the respective cell adjacent to the crack tip.

As another example, in one or some embodiments, the characteristic length L_{ch-cr} for the second grid, which in one instance may be a uniform grid, is a constant for a specific solving methodology and is indicative of dimensional aspect of the uniform grid that renders the selected numerical method fit (e.g., finite element method) with the analytical solution (e.g., resulting in a true solution). In this regard, the uniform grid with the characteristic length L_{ch-cr} may be considered to result in the correct solution for the selected numerical method used to solve the fracture propagation problem (e.g., the characteristic length L_{ch-cr} may be a first value with the uniform grid and using the finite element method versus a second value with the same uniform grid and using the finite difference method). As discussed in more detail below, the characteristic length L_{ch-cr} may be determined in one of several ways, including being empirically determined from field data or being based on simulation. Thus, the correction factor, with its two characteristic lengths, may be applied in order to reduce grid dependence when using a non-uniform grid to solve the fracture propagation problem.

Alternatively, in one or some embodiments, a uniform grid may be used in order to solve fracture propagation. In such a situation, the methodology may be used in order to select a size of cells for the uniform grid so that the selected uniform grid provides the correct result for the selected numerical method used to solve the fracture propagation problem. As discussed herein, the characteristic length L_{ch-cr} may be determined in one of several ways and represents the dimensional aspect of the uniform grid that renders the selected numerical method fit with the analytical solution (e.g., resulting in a true solution).

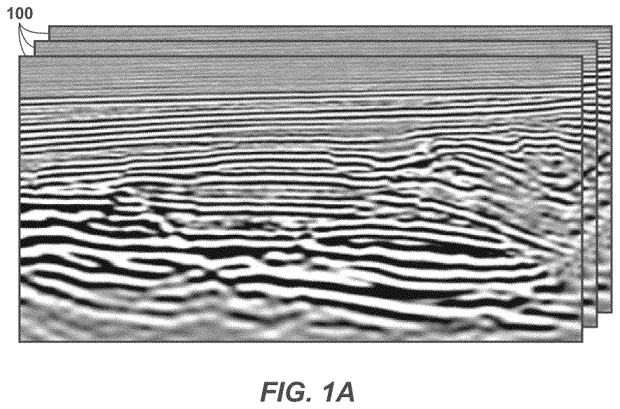

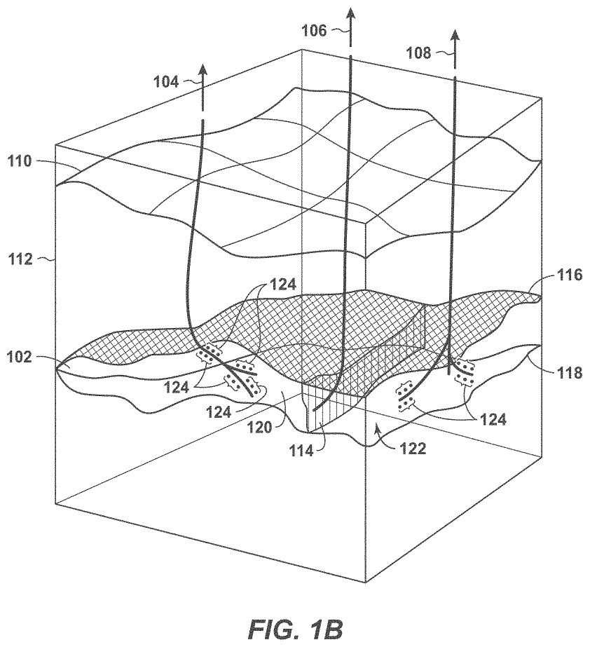

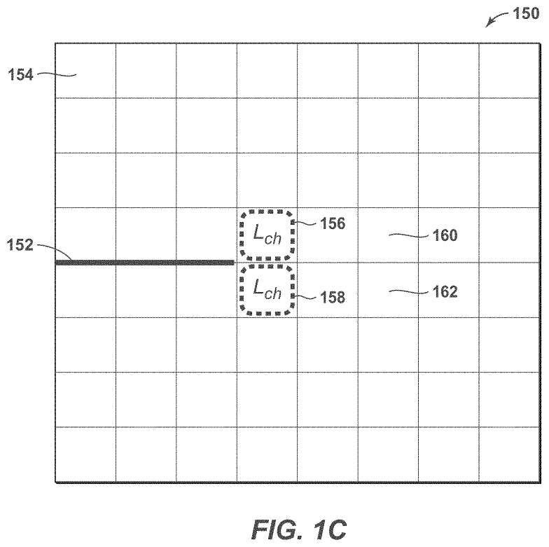

Turning now to the figures, FIG. 1A shows an illustrative measured seismic image volume 100, which can be expressed in many ways but is here shown as parallel slices of a three-dimensional volume. The measured image volume 100 is typically obtained by processing of field-recorded seismic survey traces representing seismic wave responses to shots or other sources of seismic energy triggered at various shot locations. The processing corrects for seismic wave travel times to determine reflective interface locations, and combines repeated measurements at each location to increase the signal to noise ratio. While seismic reflectivity is commonly employed, other seismic wave properties can also or alternatively be derived from the traces and used to construct the measured seismic image volume. One particular transformation is the inversion of the seismic data to estimate petrophysical parameters such as porosity, clay volume fraction, etc. that are often part the geological model.

FIG. 1B shows an illustrative subsurface model having features that may be derived from a seismic image volume. The illustrative model includes a number of surfaces defining the boundaries of a potentially hydrocarbon-bearing formation 102 that may serve as a reservoir of oil or natural gas. The model facilitates placement and drilling of wells 104, 106, 108, from the Earth's surface 110 through layers of overburden 112 to access the formation 102. The illustrative model surfaces may include faults 114 and horizons 116, 118. The surfaces may intersect in a fashion that divides the reservoir formation 102 into distinct compartments 120, 122. The petrophysical parameters of each compartment may be estimated based on the seismic image data and/or measured using logging instruments in exploratory wells.

Modern drilling techniques enable the wells 104, 106, 108 to deviate from the vertical orientation and to be directionally drilled to follow the reservoir 102. Further, the wells can be branched to increase the amount of wellbore contact with the reservoir, as shown for wells 104 and 108. The wells 104, 106, and 108, can have numerous areas with perforations 124, indicated as dots next to the wells, to provide a flow path for fluids, such as hydrocarbons, from the reservoir 102 into the wells 104, 106, and 108 for removal to the surface. Wells 104, 106, and 108 depict very long horizontal sections that maintain contact with the reservoir in an unconventional play. If properly employed, such techniques may enable faster and more efficient extraction of reservoir fluids.

The locations and paths for the wells 104, 106, and 108, and the location of the perforations 124, may be optimized performing reservoir fluid flow simulations based on the subsurface model. Subsurface models are often used as inputs to reservoir simulation programs that predict the behavior of fluids contained therein and may also predict the behavior of rocks under various scenarios of hydrocarbon recovery. Miscalculations or mistakes can be costly. For example, miscalculations may result in suboptimal locations for the wells 104, 106, and 108, potentially lacking any contact with the reservoir formation. The additional expense associated with correcting or compensating for the suboptimal well locations would typically exceed a million dollars. Subsurface model based planning and simulation provide a mechanism to identify which recovery options offer more economic, efficient, and effective development plans for a particular reservoir.

More specifically, subsurface model construction begins with extraction of surfaces from a seismic image volume, including faults, horizons, and defining any additional surfaces such as boundaries for the region of interest. The different surfaces may be adjusted and trimmed to define closed “watertight” volumes often called zones, compartments, or containers, such as zones 120 and 122. The zones of interest are those rock formations (e.g., shale, coal, sandstone, granite) that contains hydrocarbons or other resources such as, e.g., oil or natural gas. The rock formations may or may not be naturally fractured. When the zones include tight gas formations (i.e., natural gas trapped in low permeability rock such as shale), it is typically desirable to create additional fractures in the formation to increase the formation's effective permeability.

Hydraulic fracturing operations employ an injection assembly coupled to supply a high-pressure, high-volume fluid flow via the wellbore to a perforated region, where the flow exits and enters the formation around the well. The fluid flow opens existing fractures and creates new fractures. Sand grains or other “proppants” are carried by the fluid into the open fractures to prevent the fractures from reclosing when the injection process is finished. The fracture treatment may employ a single injection of fluid to one or more fluid injection locations, or it may employ multiple such injections, optionally with different fluids. Where multiple fluid injection locations are employed, they can be stimulated concurrently or in stages. Moreover, they need not be located within the same wellbore, but may for example be distributed across multiple wells or multiple laterals within a well.

An injection treatment control subsystem coordinates operation of the injection assembly components (pump trucks, feed tanks, throttles, valves, flow sensors, pressure sensors, etc.) to monitor and control the fracture treatment. The control system may be localized to a single instrument truck, or it may take the form of multiple data acquisition and processing subsystems, communication equipment, and other equipment for monitoring and controlling injection treatments applied to the subterranean region through the wellbore. The injection treatment control subsystem may be communicably linked to a remote computing facility that can calculate, select, or optimize treatment parameters for initiating, opening, and propagating fractures of the desired extent. The injection treatment control subsystem may receive, generate or modify an injection treatment plan (e.g., a pumping schedule) that specifies properties of an injection treatment to be applied to the subterranean region. Based on such modeled behavior results, the injection treatment control subsystem can control operation of the injection assembly.

Hydraulic fracturing operations produce complex fracture networks that pose steep requirements for computational modeling of physical phenomena (such as crack propagation and fluid-structure interactions) to the desired accuracy. For such modeling, it is preferred to have the surface-based model representation gridded into a volumetric mesh in which each cell (“voxel”) has homogenous or otherwise well-defined mechanical and fluid material properties and potentially has a defined fluid transmissibility to each neighboring cell with which it shares a cell face.

In one or some embodiments, the domain of the fracture network may be modeled using a pre-determined mesh. The cells of the mesh correspond to the rock, while the edges (for 2D) or faces (for 3D) correspond to the (potential) fractures. As aspects of the fluid mechanics are simulated in the presence of a rock stress distribution, fractures are initiated, opened, and/or extended along the predefined static edges or faces of the mesh.

For example, fracture propagation occurs when the maximum principal stress (σ) in a part of the subsurface exceeds the critical stress (σ_{cr}) of the material at the part of the subsurface. In equation form, this may be written as σ_{cell}>σ_{cr}. Further, a mesh, such as a grid, may be used to determine whether fracturing occurs. Various equations are contemplated for the fracture tip solution. One example is Westergaard's solution as shown in the following:

σ_{cell}(r,θ)=1/\sqrt{r}f(θ,a)σ_{farfield} (1)

where r is the distance from the crack tip, θ is the angle, a is the size of the crack as well as other constants. Manipulating Equation (1), it is shown that σ_{cell}(r, θ)*\sqrt{r} is independent of radius of location at which the stress is evaluated, which may be true only for near vicinity of the crack tip (e.g., particular with cells that are proximate to or near the crack tip). In particular, further away from the crack tip region, the radius r becomes larger and hence the term 1/\sqrt{r} becomes negligible. The higher order terms that are dependent on r may therefore take precedence. For preparing an analytical solution, specifically near the crack tip, one may assume r to be very small, so that terms based higher orders of ‘r’ become negligible.

Various numerical methods to solve the fracturing problem are contemplated. For example, numerical methods may discretize the subsurface domain into a finite number of cells, with constant stress (e.g., linearly varying displacement) approximation. As discussed in the background, in such numerical methods, the stress computed in a crack-tip cell may strongly depend on the selection of the grid (e.g., on the characteristic length of the cell in the selected grid). In other words, the stress computed may be dependent on the selected grid. This is, for example, illustrated in Equation (1) because of the inherent approximation of displacement field. In particular, a first grid may have larger cells (e.g., cells with a larger area or volume) whereas a second grid may have smaller cells (e.g., cells with a smaller area or volume). Computing the stress (σ_{cell}) associated with a respective cell depends on the distance (r) from the crack tip. Because the distance (r) from the crack tip may vary for the larger cells versus the smaller cells (e.g., if stress is calculated in the center of a respective cell, a smaller cell will have a smaller distance (r) to the crack tip versus a larger cell), the computed (σ_{cell}) associated with a respective cell will vary depending on the size of the cells.

Multiplying both sides of Equation (1) \sqrt{r} results in:

$$\sqrt{r} * {σ}_{c e l l} ( r , θ ) = \sqrt{r} * \frac{1}{\sqrt{r}} f ( θ , a ) {σ}_{f a rfield} > \sqrt{r} * {σ}_{c r} . \qquad ( 2 )$$

Thus, resulting in:

\sqrt{r}*σ_{cell}(r,θ)>\sqrt{r}*σ_{cr} (3).

Thus, there are two terms on either side of the equation: (i) \sqrt{r}*σ_{cell}(r, θ); and (ii) \sqrt{r}*σ_{cr}. The terms, either alone or in combination, may be used to determine one or more correction factors in order to reduce the dependence of stress on the chosen grid. For example, term (i) may be viewed as the basis for one or more correction factors for the mesh or the grid selected (e.g., cells for the selected non-uniform grid), and term (ii) may be as the basis for one or more correction factors for an ideal mesh or an ideal grid (e.g., an ideal uniform grid). In one or some embodiments, “ideal” may be in the sense that the selected grid or mesh has been selected where the numerical solution using the specific solving methodology (such as finite element method) matches the analytical solution. It is noted that σ_{cr} is a property of the material (e.g., the rock) and is thus considered a constant regardless of the specific solving methodology selected. However, for purposes of numerically solving with the specific solving methodology, the \sqrt{r} in the term \sqrt{r}*σ_{cr} may be the basis for an “ideal” correction factor, such as an aspect of an ideal mesh or ideal grid, for the specific solving methodology. Various aspects of the ideal mesh or ideal grid are contemplated. As one example, the ideal correction factor may be based on the characteristic length L_{ch-cr} of the ideal mesh or ideal grid, such as the square root of the characteristic length (\sqrt{L_{ch-cr}}). Various methods to determine the L_{ch-cr} are contemplated, such as based on field observation, based on an analytical solution, or based on benchmark software, as discussed further below.

In one or some embodiments, the characteristic length L_{ch-cr} of the ideal mesh or ideal grid is not considered a property of the material (e.g., a rock property) or a property of the grid or mesh: rather, the characteristic length L_{ch-cr} of the ideal mesh or ideal grid may be viewed as a parameter that renders the selected numerical method (e.g., the finite element method) fit with the analytical solution. In other words, the characteristic length L_{ch-cr} may be viewed as a connection property between the material and the selected numerical method. In this regard, different numerical methods may result in different characteristic lengths L_{ch-cr}. For example, the finite element method, which may use one or more linear elements, may have a first characteristic length L_{ch-cr-fe}, whereas other finite difference methodologies, which may use one or more higher order elements, may have a second characteristic length L_{ch-cr-fd} which is different from the first characteristic length L_{ch-cr-fe}. Thus, the characteristic length L_{ch-cr} of the ideal mesh or ideal grid may be used for the selected numerical method to match with the analytical solution.

Further, for purposes of numerically solving with the specific solving methodology, the \sqrt{r} in the term \sqrt{r}*σ_{cell} may be the basis for a mesh dependence correction factor or a grid dependence correction factor, such as an aspect of the selected non-uniform mesh or the selected non-uniform grid. Various aspects of the selected mesh or selected grid are contemplated for the basis of the mesh correction factor or a grid dependence correction factor. As one example, the mesh or grid correction factor may be based on a characteristic length L_{ch} of the selected mesh or selected grid, such as the square root of the characteristic length (\sqrt{L_{ch}}). Further, the term \sqrt{L_{ch}}*σ_{cell} may be considered less grid dependent, thereby reducing the dependence of the determined stress on the selected grid. This is particularly the case where σ_{cell} is determined proximate to the crack tip (e.g., in the vicinity of the crack tip examining cells adjacent or proximate to the crack tip). In one or some embodiments, the characteristic length L_{ch} may be indicative of or based upon a distance from the crack tip to an integration point for the cell (e.g., the point at which the stress for the cell is determined, such as at a center of the respective cell, Gauss Quadrature point, or at an interface for the respective cell). As discussed above, the characteristic length L_{ch} of the selected mesh or selected grid may be determined in one of several ways, such as based on the volume of the cell in the selected mesh or grid, the face area of the interface in a cell in the selected mesh or grid, the length along crack propagation direction in a cell in the selected mesh or grid, etc. Thus, in one or some embodiments, the characteristic length L_{ch} of the selected mesh or selected grid may be a dimension of the respective cell, such as a dimension of the respective cell along the direction of the fracture or a longest edge of the respective cell.

Thus, substituting L_{ch-cr} and L_{ch} in Equation (3) results in:

\sqrt{L_{ch}}*σ_{cell}>\sqrt{L_{ch-cr}}*σ_{cr} (4).

Further manipulating Equation (4) results in:

$${σ}_{c e l l} > \frac{1}{\sqrt{{L}_{c h} / {L}_{c h - cr}}} {σ}_{c r} . \qquad ( 5 )$$

Thus, using a correction factor

$$( e . g . , \frac{1}{\sqrt{{L}_{c h} / {L}_{c h - cr}}} ) ,$$

which may be calibrated to a material length scale, the grid dependence on crack propagation result may be reduced or minimized. In other words, for any mesh or grid that is selected which is not “ideal” (e.g., where the numerical solution does not match the analytical solution for the specific solving methodology), correction factor

$$\frac{1}{\sqrt{{L}_{c h} / {L}_{c h - cr}}}$$

may be used to reduce grid dependence for the numerical solution. Specifically,

$$\frac{1}{\sqrt{{L}_{c h} / {L}_{c h - cr}}}$$

is merely one example of a correction factor that correlates two correction factors, such as a first correction factor based on at least one aspect of the selected mesh with a second correction factor based on another aspect, such as at least one aspect of an ideal mesh (where determinations of stress for the ideal mesh are independent of the specific solving methodology). In this way, the selection of individual cell or interface may have less impact on the numerical scalability of the simulation. This is in contrast with other approaches, such as those mentioned above, in that the present methodology does not require a special discretization scheme or extra average calculation for each crack-tip cell at each step. Hence, the disclosed methodology may enable reducing or minimizing grid sensitivity with less or least impact on simulation runtimes using various solving methodologies, such as typical finite element method using finite element cells.

FIG. 1C shows in 2D fracture 152 and grid 154, with the stress computed in a crack-tip cell(s), shown as dotted cells 156, 158 in illustration 150 in FIG. 1C. In practice, the characteristic length L_{ch} in cells 156, 158 may be determined and used along with the characteristic length L_{ch-cr} order to determine fracture propagation according to Equation (5). Further, crack propagation may be iteratively performed along the direction of the crack. For example, responsive to determining crack propagation to cells 156, 158, crack propagation may be determined for cells 160, 162 using the correction factor (including the characteristic length L_{ch} in cells 160, 162 and the characteristic length L_{ch-cr}.

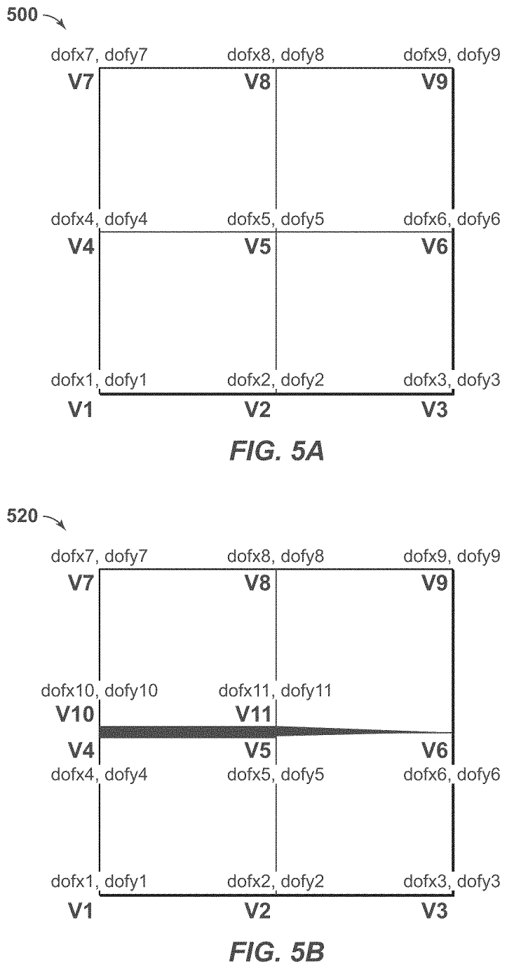

Merely for example, FIG. 5A shows an illustrative initial mesh 500 representing an unfractured formation. Nine vertices V1-V9, each having x, y coordinates (shown as dofxi, dofyi), are connected by 12 interfaces to define four cells. FIG. 5B shows an illustration 520 of a conventional approach to introducing a fracture into the formation, whereby new vertices V10 and V11 are added with corresponding coordinates and edge connections representing the fracture opening. However, the storage of (and/or access to) the additional geometrical entities associated with the additional vertices imposes undesirable time and memory burdens to the simulation process.

The pre-determined mesh may be one determined in accordance with any extant gridding strategy, and in particular, may be chosen to align some of the cell boundaries with surfaces in the surface-based model. The gridding process may be followed by assignment of petrophysical parameter values to each mesh cell and/or cell surface. Illustrative parameter values include any one, any combination, or all of: transmissibility or flow rates between cells; rock type; porosity; permeability; Biot's modulus; elastic modulus; Poisson ratio; initial stresses and pressure; rock fracture toughness; and failure stress. The transmissibility between cells on the two sides of an existing fault may also be established. Geostatistics may be used in subsurface models to interpolate observed data and to superimpose an expected degree of variability.

Locations of wells and fluid injection zones may then be determined for simulating the creation and propagation of fractures. As discussed above, the process of hydraulic fracturing involves fluids pumped down at a prescribed flow rate through the wellbore/casing and into the formation through perforations. When the fluid pressure exceeds the rock breakdown pressure, it creates a fracture in the formation. Proppants, such as sand, are pumped with fracturing fluid to keep the fracture open after release of pumping pressure. Typically a numerical method such as the finite element or finite volume method is employed to solve the governing equations of fluid flow and rock to estimate/predict the effectiveness of a fracturing treatment. Other numerical methods are contemplated. The solution to these governing equations may also drive the fracture propagation in the rock medium. Numerous methods appear in the literature for simulating fracture propagation under these conditions.

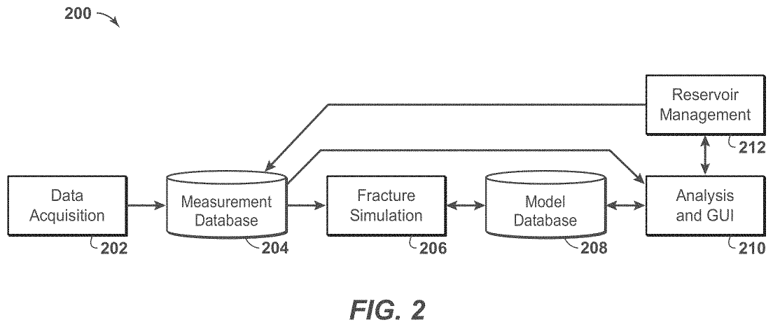

The software operating on the modeling system may be structured as indicated by the software architecture 200 shown in FIG. 2. A data acquisition module 202 stores various types of data in a measurement database 204. The measurement database may include seismic and well log data relating to hydraulic fracturing plans, as well as template plans with possible parameter ranges for performing hydraulic fracture operations. For example the operations data can indicate a pumping schedule, parameters of previous operations, and parameters of a proposed operation. Such parameters may include information on flow rates, flow volumes, proppant concentrations, fluid compositions, injection locations, injection times, or other parameters.

The measurement database may further include geological data relating to geological properties of a subterranean region. For example, the geological data may include information on wellbores, completions, or information on other attributes of the subterranean region. In some cases, the geological data includes information on the lithology, fluid content, stress profile (e.g., stress anisotropy, maximum and minimum horizontal stresses), pressure profile, spatial extent, natural fracture geometries, or other attributes of one or more rock formations in the subterranean zone. The geological data can include information collected from well logs, rock samples, outcrops, microseismic imaging, tilt measurements, or other data sources.

The measurement database may still further include fluid data relating to well fluids and entrained materials. The fluid data may identify types of fluids, fluid properties, thermodynamic conditions, and other information related to well assembly fluids. The fluid data can include flow models for compressible or incompressible fluid flow. For example, the fluid data can include coefficients for systems of governing equations (e.g., Navier-Stokes equations, advection-diffusion equations, continuity equations, etc.) that represent fluid flow generally or fluid flow under certain types of conditions. In some cases, the governing flow equations define a nonlinear system of equations. The fluid data can include data related to native fluids that naturally reside in a subterranean region, treatment fluids to be injected into the subterranean region, hydraulic fluids that operate well assembly tools, or other fluids that may or may not be related to a well assembly.

Simulation software 206 (including the fracture mapping, mesh fitting, equation construction, and solving modules mentioned above) employs the information from the measurement database 204 to locate and model the propagation of induced fractures. The mesh and fracture properties are stored in model database 208. The mesh and fracture properties may include a mapping of fractures to mesh nodes and augmentation of those nodes with additional degrees of freedom for modeling relevant properties of the fracture. A visualization and analysis module 210 generates visual representations of the fractures and measurements for an operator, generally in an interactive form that enables the operator to enhance portions of the model and derive analytical results therefrom. The visual representation may depict spatial distributions of values and/or integrated values such as injected volumes, flow rates, fracture dimensions, and estimated permeabilities. In some contemplated embodiments, the analysis module further produces recommendations for real-time modifications to treatment plans that are underway. Finally, a reservoir management module 212 may take the results of the guided analysis and capture the selected parameter values for field engineers to use in developing the reservoir. Module 212 may further update the module 210 and measurement database 204 with the parameter values employed and the measured results associated therewith.

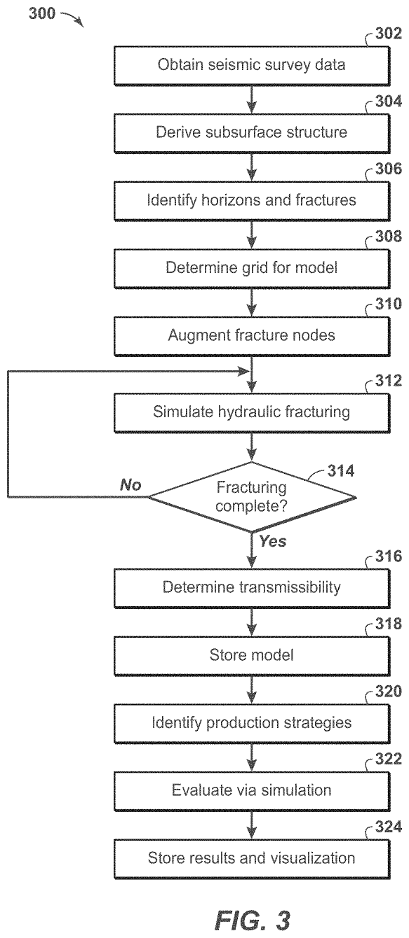

FIG. 3 is a flow diagram 300 of an illustrative subsurface modeling method. At 302, the system obtains seismic survey trace signal data pertaining to a region of interest. At 304, the system migrates and/or inverts the seismic survey traces to derive at least a high-level picture of the subsurface structure, usually embodied as a volumetric property distribution model in the physical space. At 306, the physical space model is examined to “interpret” the data (e.g., to identify horizons representing formation boundaries, faults, and any other discernable structures). In one or some embodiments, this interpretation can be automated to at least some degree (such as fully automated). Alternatively, a geologist or other professional may supervise the interpretation process and/or to perform the interpretation manually.

At 308, the system applies a gridding process to discretize the model at a resolution suitable for simulating the reservoir's response to contemplated production strategies, including well placement and completion (including perforation and fracturing operations). As discussed above, various grids (with varying cell sizes) are contemplated. The resulting mesh may include cell boundaries that conform to the boundaries of the identified subsurface structures, including fractures. Alternatively, the cell boundaries may be selected independently of the identified subsurface structures. Still alternatively, certain cell boundaries may be selected based on the boundaries of the identified subsurface structures and other cell boundaries may be selected independently of the boundaries of the identified subsurface structures. At 310, the mesh nodes on the fracture boundaries are augmented with additional degrees of freedom for representing characteristics of the fractures and the fluid flow therein.

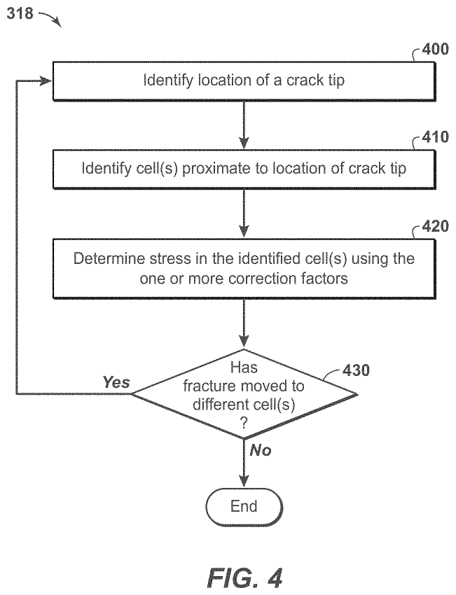

At 312, the system simulates fracture propagation by, e.g., modeling the fluid flow along fractures and into the formation, the resulting alterations of the pressure, deformation, and stress fields, and identifying failure points and probable orientations and lengths of fracture extensions. This is illustrated in more detail in FIG. 4.

At 314, the system determines if propagation is complete. If not, flow diagram 300 loops back to 312. Once complete, at 316, the system adjusts the simulation model to account for changes to formation transmissibility or permeability due to the presence of the propagated fractures. At 318, the system stores the model and simulation mesh to disk or some other form of non-transient information storage medium. At 320, the system configures the subsurface model in accordance with an identified production strategy, e.g., by specifying well locations and completion zones. At 322, the system simulates production from the reservoir to evaluate the identified strategy. 320 and 322 may be repeated as needed to evaluate different strategies and refinements thereof. At 324, the system stores at least the results of each simulation, optionally displaying the results and offering an interactive visualization of the model to a user. The above described approach may yield higher-quality results (in terms of simulation accuracy) with lower computational demands than current methods.

FIG. 4 is a flow diagram of an illustrative fracturing simulation 318 as shown in FIG. 3. At 400, a location of a crack tip is identified. At 410, one or more cells proximate to the location of the crack tip are identified. At 420, stress associated with the identified cell(s) are determined using the one or more correction factors, as discussed above with regard to the characteristic length L_{ch} for the identified cell(s) and the characteristic length L_{ch-cr}. At 430, it is determined whether the fracture has moved to different cells. If so, the flow diagram moves back to 400 in order to iterate. If not, flow diagram ends.

As discussed above, the stress associated with a particular cell may be determined for various parts of the cell, such as at a center of the particular cell or at an interface of the particular cell. Further, the governing equations associated with determining stress proximate to the crack tip may be determined in combination with the one or more correction factors. Equation (5), discussed above, is reproduced below:

$${σ}_{c e l l} > \frac{1}{\sqrt{{L}_{c h} / {L}_{c h - cr}}} {σ}_{c r} . \qquad ( 5 )$$

As discussed above, L_{ch-cr} is the characteristic length of the ideal mesh or ideal grid and L_{ch} is some aspect of the cell of the selected grid (such as a geometrical aspect of the cell in question). As discussed above, L_{ch} may be based on the volume of the cell in the selected mesh or grid, may be based on the face area of the interface in a cell in the selected mesh or grid, or may be the length along crack propagation direction in a cell in the selected mesh or grid.

Further, the characteristic length (L_{ch-cr}) of the ideal mesh or ideal grid may be determined in one of several ways. In one way, the characteristic length (L_{ch-cr}) may be determined by solving the known analytical problem and then identifying the characteristic length (L_{ch-cr}) (e.g., the value that matches the fracture simulation to the analytical problem). In another way, field data may be gathered in order to calibrate the characteristic length (L_{ch-cr}) (e.g., using the field data to empirically identify a reasonable value for the characteristic length (L_{ch-cr}).

In still another way, a benchmark simulator may be used. For example, one or more benchmark simulators, which are simulators that use a different approach(es) but that has/have result(s) that is trusted or a converged result, may be used as a comparison in order to select the characteristic length (L_{ch-cr}). The benchmark simulator(s), which may be slower than the fracture simulator, may thus be used to generate a result at one or more calibration points (e.g., less than an entire solution) so that the characteristic length (L_{ch-cr}) may be intimated from the calibration point(s).

The stress σ_{cell} may thus be determined using one or more governing equations. Various governing equations are contemplated. The below governing equations are merely one example. In this regard, other governing equations are contemplated. For example, the momentum balance for poro-elastic rock may be represented by the following:

∇·(σ′−bpI)=0 (6).

where σ′ is effective stress (positive in tension), b is Biot coefficient, p is pore pressure (positive in compression), I is Identity matrix. The stress σ′ is related to strain through an elastic or inelastic constitutive relation.

A constitutive equation relates the stress state in the rock, σ in Equation (6), to the strains in the rock. For example, one elastic constitutive relation is given by σ′=C: ϵ where C is elastic modulus tensor and e is rock strain. Finally, the strains ϵ and the displacements u are related as:

$$ϵ = \frac{1}{2} [ grad ( u ) + {( g r a d ( u ) )}^{T} ] . \qquad ( 7 )$$

The porous flow governing equation may then be represented as:

$$\frac{1}{M} \frac{\partial p}{\partial t} + b ∇ \cdot {v}_{s} + ∇ \cdot ( k ∇ p ) = 0. \qquad ( 8 )$$

where M is the Biot's modulus, vₛ is the velocity of rock, and k is the permeability of flow in the rock. Equation (8) may be written in multiple forms, such as based on compressibility, incorporating gravity, single/multiple phases of fluid, etc. In this regard, the disclosed equations are merely illustrative. Further, the above poro-elastic rock governing equations may be solved along with wellbore, perforation, fracture flow and leak-off.

Though the operations shown and described in the flow diagrams in FIG. 3 and FIG. 4 are treated as being sequential for explanatory purposes, in practice the method may be carried out by multiple processors operating concurrently and perhaps even speculatively to enable out-of-order operations. The ordering and sequential treatment is not meant to be limiting. These and numerous other modifications, equivalents, and alternatives, will become apparent to those skilled in the art once the above disclosure is fully appreciated. It is intended that the following claims be interpreted to embrace all such modifications, equivalents, and alternatives where applicable.

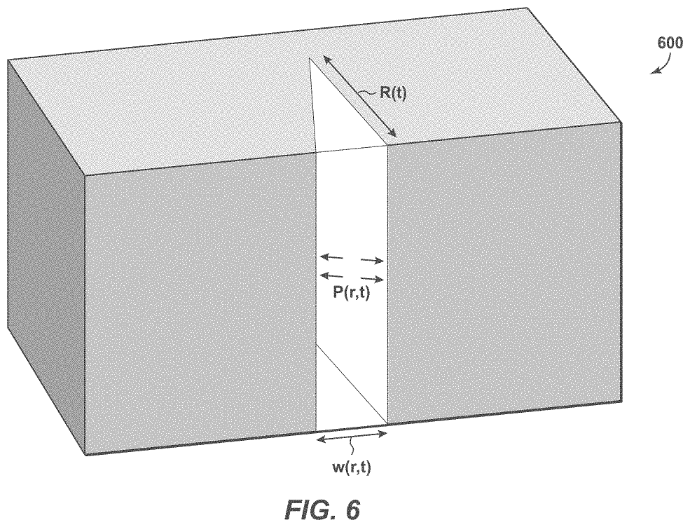

FIG. 6 is an illustration 600 of a Kristianovich-Geertsma-de Klerk (KGD) propagation benchmark model. The KGD propagation benchmark model is merely one example of a 2-D model with analytical solution available in the literature. Other 2-D models and 3-D models are contemplated. R(t) is the maximum extent of the fracture, σ₀ are various side pressures, w(r, t) is the width of the fracture, p(r, t) is the downhole pressure.

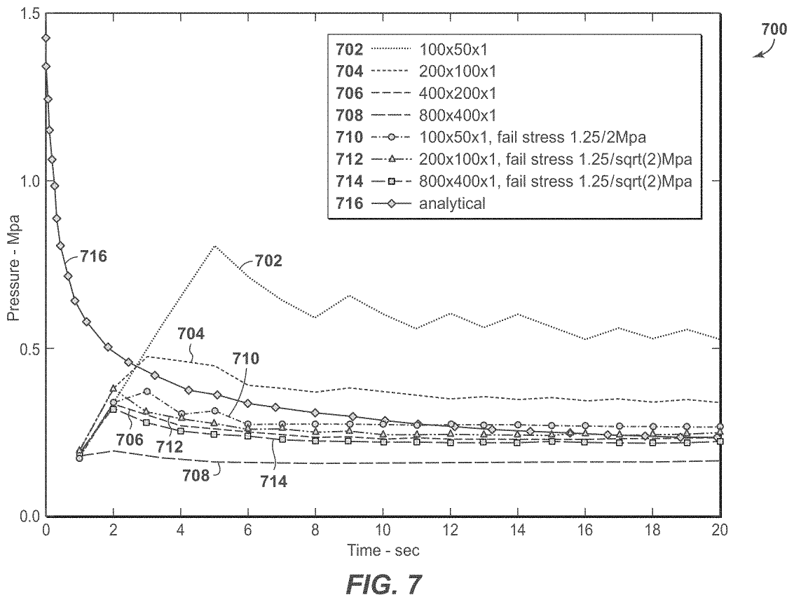

FIG. 7 is a graph 700 of the numerical result for pressure at the inlet with time for the KGD problem (such as illustrated in FIG. 6) in the x-y direction. Graph 700 shows the curve 716 for the analytical result of pressure and the curves 702, 704, 706, 708 for the traditional determination of pressure using grid sizes 100×50×1, 200×100×1, 400×200×1, and 800×400×1, respectively. For example, grid size 100×50×1 translate into the subsurface being divided into 100 sections in the x direction, 50 sections in the y direction and 1 section in the z direction. As another example, grid size 200×100×1 translate into the subsurface being divided into 200 sections in the x direction, 100 sections in the y direction and 1 section in the z direction. In this regard, grid size 200×100×1 have twice the number of cells in both the x and y directions than grid size 100×50×1. Finally, grid size 800×400×1 translate into the subsurface being divided into 800 sections in the x direction, 400 sections in the y direction and 1 section in the z direction. Thus, grid size 800×400×1 have four times the number of cells in both the x and y directions than grid size 200×100×1.

As shown, curves 702 and 704 are above the curve 716 for the analytical result of pressure whereas curves 706 and 708 are below the curve 716 for the analytical result. This illustrates that the determination of pressure is dependent on the selection of the grid, as discussed above. In this case, it is hypothesized that using σ_{cr}=1.25 MPa on the grid 400×200×1 provides the solution matching with the analytical solution. Hence characteristic length L_{ch-cr} is obtained from cell dimension in x-direction of this ideal grid. Curves 710, 712, 714, are generated using the correction factor as shown above in Equation (5) for grid sizes 100×50×1, 200×100×1, and 800×400×1, respectively. Note that the correction factor for the grid 400×200×1 is unity (1.0), because the characteristic length for this grid L_{ch}=L_{ch-cr}. Each of the curves 710, 712, 714 use the same characteristic length (L_{ch-cr}) of the ideal mesh or ideal grid but use different characteristic length L_{ch}, which is here taken as cell dimension in x-direction of the selected grid.

In this regard, the right hand side of equation (5),

$${σ}_{c e l l} > \frac{1}{\sqrt{{L}_{c h} / {L}_{c h - cr}}} {σ}_{cr} ,$$

that includes the correction factor and critical stress 1.25 MPa for grid 100×50×1=1.25*½ Megapascals (MPa), grid 200×100×1=1.25*1/\sqrt{2}MPa, and grid 800×400×1=1.25*\sqrt{2}MPa. If the x-dimension of cell in the ideal grid (400×200×1) is L_{ch-cr}=α, then the corresponding characteristic length in 100×50×1 is L_{ch}=4α, hence

$$\frac{1}{\sqrt{{L}_{c h} / {L}_{c h - cr}}} = \frac{1}{2} .$$

Similarly the characteristic length in 200×100×1 is L_{ch}=2α, resulting in

$$\frac{1}{\sqrt{{L}_{c h} / {L}_{c h - cr}}} = \frac{1}{\sqrt{2}} ,$$

and the characteristic length in 800×400×1 is L_{ch}=α/2, resulting in

$$\frac{1}{\sqrt{{L}_{c h} / {L}_{c h - cr}}} = \sqrt{2} .$$

Generally speaking, curves 710, 712, 714, more closely follow the curve 716 for the analytical result. More specifically, comparing the curves for the same grid size (such as curve 702 (using the traditional determination of pressure) for grid size 100×50×1 versus curve 710 (using the correction factor of Equation (5)) for grid size 100×50×1) highlights that the curves generated using the correction factor are less dependent on the selection of the grid size.

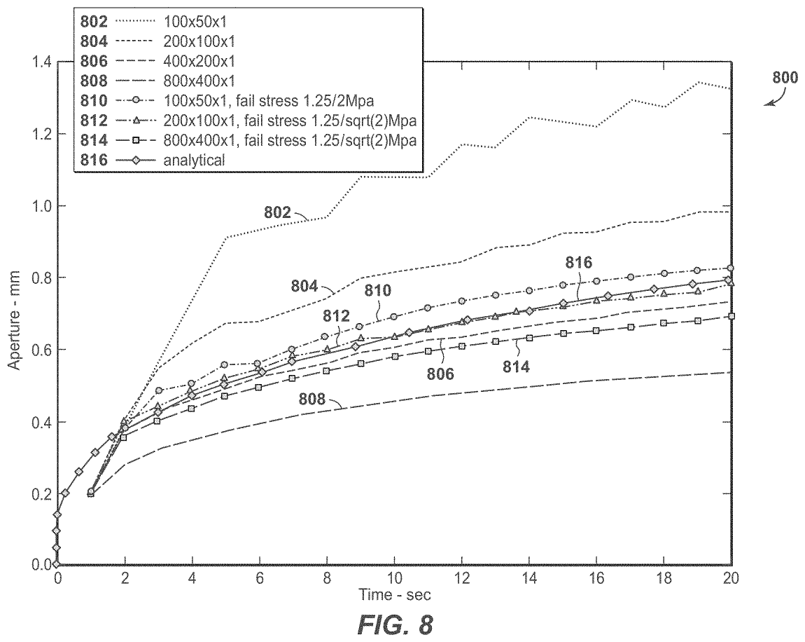

FIG. 8 is a graph 800 of the numerical result for aperture with time for the KGD problem (such as illustrated in FIG. 6) in the x-y direction. Graph 800 shows the curve 816 for the analytical result of aperture and the curves 802, 804, 806, 808 for the traditional determination of aperture using grid sizes 100×50×1, 200×100×1, 400×200×1, and 800×400×1, respectively. As shown, curves 802 and 804 are above the curve 816 for the analytical result of aperture whereas curves 806 and 808 are below the curve 816 for the analytical result. This illustrates that the determination of aperture is dependent on the selection of the grid, as discussed above. Curves 810, 812, 814, are generated using the correction factor as shown above in Equation (5) for grid sizes 100×50×1, 200×100×1, and 800×400×1, respectively. Similar to FIG. 7, each of curves 810, 812, 814 use the same characteristic length L_{ch-cr} of the ideal mesh or ideal grid (400×200×1) but use different characteristic length L_{ch}, which is x-dimension of the cell of the selected grid. Generally speaking, curves 810, 812, 814 more closely follow the curve 816 for the analytical result of aperture. More specifically, comparing the curves for the same grid size such as curve 802 (using the traditional determination of pressure) for grid size 100×50×1 versus curve 810 (using the correction factor of Equation (5)) for grid size 100×50×1 highlights that the curves generated for aperture using the correction factor are less dependent on the selection of the grid size. Thus, similar to FIG. 7, FIG. 8 illustrates that using the disclosed methodology reduces dependence of the determined results (such as one or both of pressure and aperture) on the selection of the grid.

Further, in one or some embodiments, the methodology may be used to select the cell size for a uniform grid in order to reduce or eliminate grid dependence for the selected numerical method. As discussed above, the determined stress may be dependent on the selected cell size. In order to reduce this dependence, a correction factor, such as detailed in Equation (5), may be used. In the instance where a uniform grid is used to determine crack propagation, the characteristic length L_{ch} is constant (the cells in the uniform grid are identical, meaning that the characteristic length L_{ch} is the same for all the cells). Thus, selecting the characteristic length L_{ch} to be equal to the characteristic length L_{ch-cr} results in the correction factor being 1.

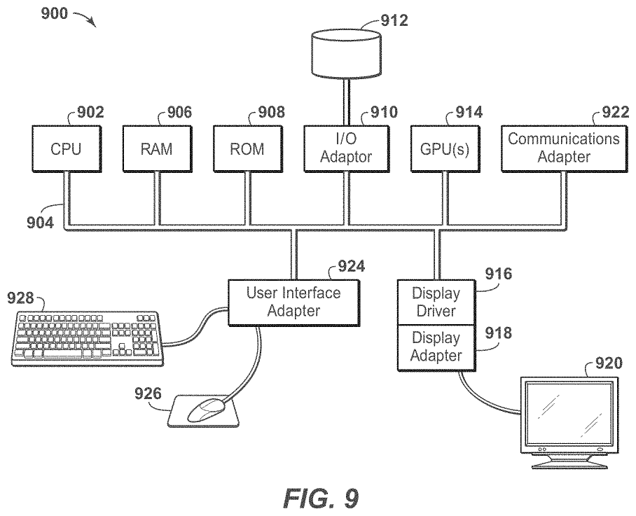

In all practical applications, the present technological advancement must be used in conjunction with a computer, programmed in accordance with the disclosures herein. For example, FIG. 9 is a diagram of an exemplary computer system 900 that may be utilized to implement methods described herein. A central processing unit (CPU) 902 is coupled to system bus 904. The CPU 902 may be any general-purpose CPU, although other types of architectures of CPU 902 (or other components of exemplary computer system 900) may be used as long as CPU 902 (and other components of computer system 900) supports the operations as described herein. Those of ordinary skill in the art will appreciate that, while only a single CPU 902 is shown in FIG. 9, additional CPUs may be present. Moreover, the computer system 900 may comprise a networked, multi-processor computer system that may include a hybrid parallel CPU/GPU system. The CPU 902 may execute the various logical instructions according to various teachings disclosed herein. For example, the CPU 902 may execute machine-level instructions for performing processing according to the operational flow described.

The computer system 900 may also include computer components such as non-transitory, computer-readable media. Examples of computer-readable media include computer-readable non-transitory storage media, such as a random access memory (RAM) 906, which may be SRAM, DRAM, SDRAM, or the like. The computer system 900 may also include additional non-transitory, computer-readable storage media such as a read-only memory (ROM) 908, which may be PROM, EPROM, EEPROM, or the like. RAM 906 and ROM 908 hold user and system data and programs, as is known in the art. The computer system 900 may also include an input/output (I/O) adapter 910, a graphics processing unit (GPU) 914, a communications adapter 922, a user interface adapter 924, a display driver 916, and a display adapter 918.

The I/O adapter 910 may connect additional non-transitory, computer-readable media such as storage device(s) 912, including, for example, a hard drive, a compact disc (CD) drive, a floppy disk drive, a tape drive, and the like to computer system 900. The storage device(s) may be used when RAM 906 is insufficient for the memory requirements associated with storing data for operations of the present techniques. The data storage of the computer system 900 may be used for storing information and/or other data used or generated as disclosed herein. For example, storage device(s) 912 may be used to store configuration information or additional plug-ins in accordance with the present techniques. Further, user interface adapter 924 couples user input devices, such as a keyboard 928, a pointing device 926 and/or output devices to the computer system 900. The display adapter 918 is driven by the CPU 902 to control the display on a display device 920 to, for example, present information to the user such as subsurface images generated according to methods described herein.

The architecture of computer system 900 may be varied as desired. For example, any suitable processor-based device may be used, including without limitation personal computers, laptop computers, computer workstations, and multi-processor servers. Moreover, the present technological advancement may be implemented on application specific integrated circuits (ASICs) or very large scale integrated (VLSI) circuits. In fact, persons of ordinary skill in the art may use any number of suitable hardware structures capable of executing logical operations according to the present technological advancement. The term “processing circuit” encompasses a hardware processor (such as those found in the hardware devices noted above), ASICs, and VLSI circuits. Input data to the computer system 900 may include various plug-ins and library files. Input data may additionally include configuration information.

Preferably, the computer is a high performance computer (HPC), known to those skilled in the art. Such high performance computers typically involve clusters of nodes, each node having multiple CPU's and computer memory that allow parallel computation. The models may be visualized and edited using any interactive visualization programs and associated hardware, such as monitors and projectors. The architecture of system may vary and may be composed of any number of suitable hardware structures capable of executing logical operations and displaying the output according to the present technological advancement. Those of ordinary skill in the art are aware of suitable supercomputers available from Cray or IBM or other cloud computing based vendors such as Microsoft, Amazon.

The above-described techniques, and/or systems implementing such techniques, can further include hydrocarbon management based at least in part upon the above techniques, including using the one or more generated geological models in one or more aspects of hydrocarbon management. For instance, methods according to various embodiments may include managing hydrocarbons based at least in part upon the one or more generated geological models and data representations (e.g., seismic images, feature probability maps, feature objects, etc.) constructed according to the above-described methods. In particular, such methods may include drilling a well, and/or causing a well to be drilled, based at least in part upon the one or more generated geological models and data representations discussed herein (e.g., such that the well is located based at least in part upon a location determined from the models and/or data representations, which location may optionally be informed by other inputs, data, and/or analyses, as well) and further prospecting for and/or producing hydrocarbons using the well.

It is intended that the foregoing detailed description be understood as an illustration of selected forms that the invention can take and not as a definition of the invention. It is only the following claims, including all equivalents which are intended to define the scope of the claimed invention. Further, it should be noted that any aspect of any of the preferred embodiments described herein may be used alone or in combination with one another. Finally, persons skilled in the art will readily recognize that in preferred implementation, some or all of the steps in the disclosed method are performed using a computer so that the methodology is computer implemented. In such cases, the resulting physical properties model may be downloaded or saved to computer storage.

The following example embodiments of the invention are also disclosed:

Embodiment 1. A computer-implemented geologic modeling method comprising:
accessing a geologic model representing a subsurface region as a grid of cells, at least some of the cells in the grid having one or more interfaces representing boundaries of subsurface structures including at least one natural or induced fracture;
determining, using a specific solving methodology, a fracture extension to the at least one natural or induced fracture into at least one cell in the grid by comparing stress associated with the at least one cell with critical stress associated with a material of the at least one cell, the determination using at least one correction factor correlating at least one aspect of the at least one cell in the grid with at least one aspect unrelated to the grid; and
using the fracture extension in order to control at least one aspect of hydraulic fracturing in the subsurface region.
Embodiment 2. The method of embodiment 1:
wherein the at least one correction factor comprises a first correction factor based on the at least one cell in the grid and a second correction factor based on a separate grid.
Embodiment 3. The method of any of embodiments 1 or 2,
wherein the second correction factor is selected based on one of an ideal grid in which an analytical solution matches a simulated solution using the specific solving methodology, on output from a benchmark simulator, or on corroboration with field data.
Embodiment 4. The method of any of embodiments 1-3,
wherein the grid comprises a uniform or a non-uniform grid; and
wherein the separate grid comprises a uniform grid.
Embodiment 5. The method of any of embodiments 1-4,
wherein the at least one correction factor comprises a grid dependence correction factor and an ideal correction factor, the grid dependence correction factor reducing dependence of the at least one cell in the grid on the stress determined to be associated with the at least one cell;
wherein the grid dependence correction factor is based on at least one aspect of the at least one cell; and
wherein the ideal correction factor is based on a separate grid.
Embodiment 6. The method of any of embodiments 1-5,
wherein the grid dependence correction factor is based on a characteristic length associated with the at least one cell in the grid.
Embodiment 7. The method of any of embodiments 1-6,
wherein the grid dependence correction factor comprises a square root of the characteristic length associated with the at least one cell.
Embodiment 8. The method of any of embodiments 1-7,
wherein the characteristic length is based on a volume of the at least one cell.
Embodiment 9. The method of any of embodiments 1-8,
wherein the characteristic length is based on a face area of interface at the fracture extension.
Embodiment 10. The method of any of embodiments 1-9,
wherein the characteristic length is based on a length along a crack propagation direction for the fracture extension.
Embodiment 11. The method of any of embodiments 1-10,
wherein the ideal correction factor is based on a characteristic length associated with the cell in the ideal grid.
Embodiment 12. The method of any of embodiments 1-11,
wherein the ideal correction factor comprises a solving methodology correction factor for coupling the specific solving methodology with the material of the at least one cell.
Embodiment 13. The method of any of embodiments 1-12,
wherein the characteristic length associated with the ideal grid is determined by identifying a value of the specific solving methodology for simulating the fracture extension that matches a true solution for the fracture extension.
Embodiment 14. The method of any of embodiments 1-13,
wherein the grid dependence correction factor is based on a distance of a crack tip of the fracture to a part of the at least one cell at which stress is calculated;
wherein the ideal correction factor is based on a characteristic length associated with the ideal grid; and
wherein the at least one correction factor is based on a square root of the characteristic length divided by a square root of the distance.
Embodiment 15. The method of any of embodiments 1-14,
wherein the specific solving methodology comprises finite element method or finite volume method.
Embodiment 16. The method of any of embodiments 1-15,
wherein comparing the stress associated with the at least one cell with the critical stress associated with a material of the at least one cell comprises comparing the stress inside the at least one cell with the critical stress associated with the material of the at least one cell.
Embodiment 17. The method of any of embodiments 1-16,
wherein the fracture is used in order to control transport parameters for proppant passing through a hydraulic fracture network.
Embodiment 18. The method of any of embodiments 1-17,
wherein the transport parameters controlled include pressure at which the proppant is pumped.
Embodiment 19. The method of any of embodiments 1-18,
wherein the fracture is used in order to determine fracture dimensions of the hydraulic fractures.
Embodiment 20. A computer-implemented geologic modeling method comprising:
determining a uniform grid of cells in order to represent a subsurface region by selecting a size of the cells in the uniform grid so that determinations of stress for the cells in the uniform grid for a specific solving methodology are in agreement with a true solution, at least some of the cells in the grid having one or more interfaces representing boundaries of subsurface structures including at least one natural or induced fracture;
determining, using the specific solving methodology, a fracture extension to the at least one natural or induced fracture into at least one cell in the grid by comparing stress associated with the at least one cell with critical stress associated with a material of the at least one cell; and
using the fracture extension in order to control at least one aspect of hydraulic fracturing in the subsurface region.

The following references are hereby incorporated by reference herein in their entirety, to the extent they are consistent with the disclosure of the present invention:
Thomas-Peter Fries, Ted Belytschko, The extended/generalized finite element method: An overview of the method and its applications, International Journal for Numerical Methods in Engineering, Volume 84, Issue 3, 2010.
J. Stolk, N. Verdonschot, K. A. Mann, R. Huiskes, Prevention of mesh-dependent damage growth in finite element simulations of crack formation in acrylic bone cement, Journal of Biomechanics, vol. 36, 2003.
Geertsma, de Klerk: A Rapid Method of Predicting Width and Extent of Hydraulically Induced Fractures. JPT 246, 1571-1581, 1969.

What is claimed is:

1. A computer-implemented geologic modeling method comprising:
accessing a geologic model representing a subsurface region as a grid of cells, at least some of the cells in the grid having one or more interfaces representing boundaries of subsurface structures including at least one natural or induced fracture;
determining, using a specific solving methodology, a fracture extension to the at least one natural or induced fracture into at least one cell in the grid by comparing stress associated with the at least one cell with critical stress associated with a material of the at least one cell, the determination using at least one correction factor correlating at least one aspect of the at least one cell in the grid with at least one aspect unrelated to the grid; and
using the fracture extension in order to control at least one aspect of hydraulic fracturing in the subsurface region.

2. The method of claim 1, wherein the at least one correction factor comprises a first correction factor based on the at least one cell in the grid and a second correction factor based on a separate grid.

3. The method of claim 2, wherein the second correction factor is selected based on one of an ideal grid in which an analytical solution matches a simulated solution using the specific solving methodology, on output from a benchmark simulator, or on corroboration with field data.

4. The method of claim 2, wherein the grid comprises a uniform or a non-uniform grid; and
wherein the separate grid comprises a uniform grid.

5. The method of claim 1, wherein the at least one correction factor comprises a grid dependence correction factor and an ideal correction factor, the grid dependence correction factor reducing dependence of the at least one cell in the grid on the stress determined to be associated with the at least one cell;
wherein the grid dependence correction factor is based on at least one aspect of the at least one cell; and
wherein the ideal correction factor is based on a separate grid.

6. The method of claim 5, wherein the grid dependence correction factor is based on a characteristic length associated with the at least one cell in the grid.

7. The method of claim 6, wherein the grid dependence correction factor comprises a square root of the characteristic length associated with the at least one cell.

8. The method of claim 7, wherein the characteristic length is based on a volume of the at least one cell.

9. The method of claim 7, wherein the characteristic length is based on a face area of interface at the fracture extension.

10. The method of claim 7, wherein the characteristic length is based on a length along a crack propagation direction for the fracture extension.

11. The method of claim 5, wherein the ideal correction factor is based on a characteristic length associated with the cell in the ideal grid.

12. The method of claim 11, wherein the ideal correction factor comprises a solving methodology correction factor for coupling the specific solving methodology with the material of the at least one cell.

13. The method of claim 12, wherein the characteristic length associated with the ideal grid is determined by identifying a value of the specific solving methodology for simulating the fracture extension that matches a true solution for the fracture extension.

14. The method of claim 5, wherein the grid dependence correction factor is based on a distance of a crack tip of the fracture to a part of the at least one cell at which stress is calculated;
wherein the ideal correction factor is based on a characteristic length associated with the ideal grid; and
wherein the at least one correction factor is based on a square root of the characteristic length divided by a square root of the distance.

15. The method of claim 1, wherein the specific solving methodology comprises finite element method or finite volume method.

16. The method of claim 1, wherein comparing the stress associated with the at least one cell with the critical stress associated with a material of the at least one cell comprises comparing the stress inside the at least one cell with the critical stress associated with the material of the at least one cell.

17. The method of claim 1, wherein the fracture is used in order to control transport parameters for proppant passing through a hydraulic fracture network.

18. The method of claim 17, wherein the transport parameters controlled include pressure at which the proppant is pumped.

19. The method of claim 1, wherein the fracture is used in order to determine fracture dimensions of the hydraulic fractures.

20. A computer-implemented geologic modeling method comprising:
determining a uniform grid of cells in order to represent a subsurface region by selecting a size of the cells in the uniform grid so that determinations of stress for the cells in the uniform grid for a specific solving methodology are in agreement with a true solution, at least some of the cells in the grid having one or more interfaces representing boundaries of subsurface structures including at least one natural or induced fracture;
determining, using the specific solving methodology, a fracture extension to the at least one natural or induced fracture into at least one cell in the grid by comparing stress associated with the at least one cell with critical stress associated with a material of the at least one cell; and
using the fracture extension in order to control at least one aspect of hydraulic fracturing in the subsurface region.
